(19) United States
(12) Patent Application Publication
(10) Pub. No.: US 2008/0150193 A1
(43) Pub. Date: Jun. 26, 2008

(54) METHOD OF MANUFACTURE OF A MOLDED HOLLOW USING TANGENTIAL STRUCTURES

(76) Inventors: Van T. Walworth, Lebanon, TN (US); Joseph C. Bacarella, LaSalle, MI (US); David B. Hook, Franklin, TN (US); William McGinn, Paragould, AR (US)

Correspondence Address: HARNESS, DICKEY & PIERCE, P.L.C., P.O. BOX 828, BLOOMFIELD HILLS, MI, 48303, US

(21) Appl. No.: 11/955,784

(22) Filed: Dec. 13, 2007

Related U.S. Application Data
(60) Provisional application No. 60/875,187, filed on Dec. 15, 2006.

(51) Int. Cl. B28B 1/02

(52) U.S. Cl. 264/310

(57) ABSTRACT

An improved method of molding an extended product having a longitudinal hollow through the center, wherein the use of numerous lateral chaplets to stabilize the product core during the molding process is significantly reduced or eliminated. Tangential structures positioned on a core suspended throughout the length of the cavity will eliminate or minimize the need for chaplets or other core stabilizing means. The core is placed in the open cavity of a mold used to manufacture rubber products and is suspended throughout the length of the cavity. The tangential structures on the core will maintain the suspended position of the core as rubber flows around it filling the cavity. After the cavity is filled and vulcanization of the rubber is complete, the mold is opened and the core is removed from the cavity with the molded product intact. Upon removal from the mold, the core is extracted from the product. The product is ready for post-molding operations and the core is returned to the mold and readied for the next molding cycle.

### CROSS-REFERENCE TO RELATED APPLICATIONS

This application claims the benefit of U.S. Provisional Application No. 60/875,187, filed on Dec. 15, 2006. The disclosure of the above application is incorporated herein by reference.

### FIELD

The present disclosure relates to the manufacturing of molded products. More specifically, the present disclosure pertains to the method of manufacturing extended length molded products having a longitudinal passage therethrough.

### BACKGROUND

The statements in this section merely provide background information related to the present disclosure and may not constitute prior art.

Rubber products, such as tubes and hoses, are manufactured by an extrusion processor by a molding process. Extrusion methods provide an opportunity for tubes and hoses to have simple or complex shapes for the hollow that extends through the length of the product. Extruded hollow shapes will have a consistent shape throughout the length of the extruded product. The length of extruded products is virtually unlimited depending on the continuous manufacturing equipment.

Molded products, such as tubes and hoses with a hollow through the length of the product, may also have simple or complex shapes, but the length of the hollow is limited compared to extruded manufacturing. Therefore, molded hollows are manufactured with cores that must be suspended in the mold as rubber is introduced to the cavity. Suspended cores commonly use chaplets to stabilize and maintain the location of the core along the length of the cavity. The specific geometry of the core dictates how long it can be in suspension before external chaplets are required.

Some preferred embodiments of a product that benefits from the proposed method of manufacture require a hollow throughout its length that is both wide and thin, which is similar in shape to a strip of ribbon. After manufacture, a similarly-shaped wide and thin metal beam is inserted through the hollow as one of several assembled components. In the preferred embodiment of a windshield wiper, a molded rubber product offers some desirable performance characteristics compared to the same rubber product manufactured by extrusion means. Therefore, a molded wiper product with a relatively wide and thin hollow shape will require a core to be suspended throughout the length of the molded part. Furthermore, it stands to reason that the core will require the use of chaplets and/or other suspension means to maintain the core in the proper position during introduction of rubber into the cavity around the suspended core.

A molded product with a hollow of some length must be suspended in the cavity prior to the introduction of rubber around the core filling of the cavity. The introduction of rubber often displaces the core and/or bends it and/or flows around it in such a way that the final hollow does not maintain its desired shape, resulting in poor performance of the final product.

In order to compensate for the forces that rubber imparts to the suspended core while filling the cavity, a series of chaplets is often employed at appropriate intervals to provide resistance to the dislocation. These juxtaposed chaplets leave permanent structures and/or witness lines on the outside of the final product that may interfere with the function of the product.

Another disadvantage of chaplet structures is that they may create cosmetically-undesirable molded shapes on the outside of the product. Either the shape must be tolerated by the consumer or covered with a separate component in the final assembly to hide the chaplet structure from view.

Another disadvantage of chaplet structures in the mold is that a thin rubber flash will flow into tiny clearance gaps in the mold construction at the location of the chaplet structures. The rubber flash is often very difficult to control, minimize or eliminate and often very difficult and/or expensive to remove from the final molded product.

Lastly, another disadvantage of chaplet structures in the mold is that they are difficult and expensive to machine and install in the mold due to the precision required in making them align with the position of the suspended core. In addition, proper molding conditions are difficult to maintain in chaplet structures during ongoing production cycles of the product.

### SUMMARY

Therefore, in view of the aforementioned shortcomings in the prior art, it is an objective of the present invention to provide a molded rubber part that is relatively long with an internal hollow throughout the length of the part.

A further object of the present invention is to provide a hollow that will receive a metal or plastic beam which has a relatively wide and thin cross-sectional shape.

Another object of the present invention is that the cross sectional shape of the hollow will deviate from the relative shape of the beam to be inserted therein, such that a tangential cross-sectional structure is present in the molded hollow.

A further object of the subject method is that a correspondingly-shaped core forms the said tangential cross sectional structures in the hollow.

Another object of the present invention is to provide a method of forming the tangential structure forms in a general “T” shape in the preferred embodiment, with variations of the theme providing other tangential structures.

Another object of the present method is that the structural integrity of the tangential core is sufficient for suspension of the core in the mold to prevent the need for traditional use of chaplet structures.

It is a further objective of the present method that relatively long cores may require the use of chaplets at very widely-spaced intervals compared to the relatively close juxtaposed locations required by prior art methods.

It is an object of the subject method that the tangential cross-sectional structure of the core will be sufficient to withstand side loads imposed on the core by rubber filling the cavity, thereby maintaining its shape through the length of the part.

Unlike extrusion methods, it is an object of the present invention to provide a method of producing curved and/or irregularly-shaped products as well as relatively long and straight products.

Unlike extrusion methods, it is an object of the present invention that the hollow need not maintain a consistent cross-sectional profile throughout the length of the hollow. Rather, some structural variation can exist at various locations throughout the length of the product. It is an objective of the subject method that said variations along the length of the suspended core may comprise a constant variant such, as a continuous taper or an intermittent, irregular profile.

These and other objectives will be apparent in the present invention, disclosing a method of manufacturing molded rubber products, which feature a hollow throughout the length of the product. Typical products include specialized windshield wipers, tubes and/or hose-type products. Tangential structures on a core suspended throughout the length of the cavity will eliminate or minimize the need for chaplets or other core-stabilizing means. The core is placed in the open cavity of a mold used to manufacture rubber products and suspended throughout the length of the cavity. The mold is then closed and rubber is introduced to the cavity by one of several normal means, such as compression, transfer, or injection processes. The tangential structures on the core will maintain the suspended position of the core as rubber flows around it filling the cavity. After the cavity is filled and vulcanization of the rubber is complete, the mold is opened and the core is removed from the cavity with the molded product intact. Upon removal from the mold, the core is extracted from the product. The product is ready for post molding operations and the core is returned to the mold and readied for the next molding cycle.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a beam-style wiper blade assembly comprising the preferred embodiment of the present invention;

FIG. 2 is a perspective view of a prior art beam-style wiper blade assembly illustrating the plurality of undesirable chaplets thereupon the resilient member;

FIG. 3a is a cross-sectional end view of the resilient member of the prior art wiper assembly of FIG. 2;

FIG. 4a is a cross-sectional end view of a first embodiment for a resilient member of a wiper assembly formed by the method of this invention;

FIG. 4b is a cross-sectional end view of a second embodiment for a resilient member of a wiper assembly formed by the method of this invention;

FIG. 4c is a cross-sectional end view of a further embodiment for a resilient member of a wiper assembly formed by the method of this invention;

FIG. 5a is a cross-sectional end view of a further embodiment for a resilient member of a wiper assembly formed by the method of this invention;

FIG. 5b is a cross-sectional end view of a further embodiment for a resilient member of a wiper assembly formed by the method of this invention;

FIG. 6a is a cross-sectional end view of a further embodiment for a resilient member of a wiper assembly formed by the method of this invention;

FIG. 6b is a cross-sectional end view of a further embodiment for a resilient member of a wiper assembly formed by the method of this invention;

FIG. 6c is a cross-sectional end view of a further embodiment for a resilient member of a wiper assembly formed by the method of this invention;

FIG. 7a is a cross-sectional end view of the embodiment shown in FIG. 4a further illustrating the location of the beam member;

FIG. 7b is a cross-sectional end view of the embodiment shown in FIG. 4b further illustrating the location of the beam member;

FIG. 7c is a cross-sectional end view of the embodiment shown in FIG. 4b further illustrating the location of the beam member;

FIG. 8 is a perspective view of a beam-style wiper blade assembly comprising a further embodiment of the present invention;

FIG. 9 is a partial perspective view of a further embodiment of the present invention showing the chaplets at the location of the wiper blade connector/shroud mounting; and

FIG. 10 is a partial perspective view of the embodiment of FIG. 10 showing the chaplets concealed by the attached shroud/connector element.

### DETAILED DESCRIPTION

The following description is merely exemplary in nature and is not intended to limit the present disclosure, application, or uses. It should be understood that throughout the drawings, corresponding reference numerals indicate like or corresponding parts and features.

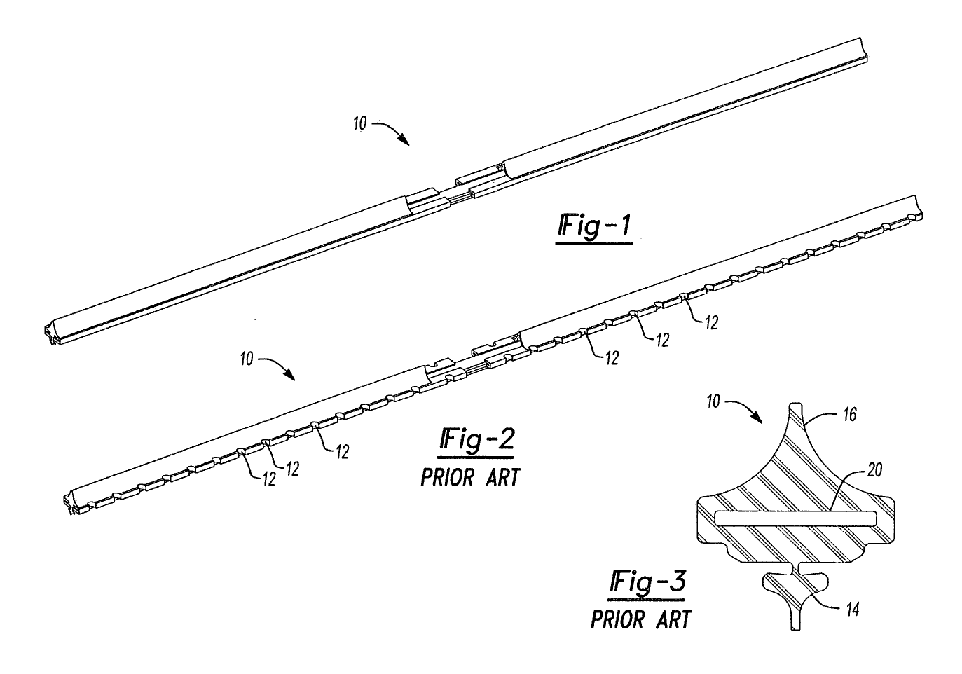

Referring now to the figures, in particular FIG. 1, a preferred embodiment of the present invention is shown. A molded rubber product, such as a windshield wiper 10, is shown manufactured by the process disclosed herein so as the cosmetic exterior is free from molded flaws that are undesirable to consumers. This is the result of the present invention's method of molding and is advantageous over the prior art shown in FIGS. 2 and 3, wherein the windshield wiper blade has numerous chaplets 12 positioned along the length thereof, which was required before the present invention, to stabilize the core during the molding process. FIG. 3, in particular, illustrates a cross section of the prior art windshield wiper 10 having a wiping blade 14 and a wind deflector 16, whereas the hollow aperture 20, running longitudinally through windshield wiper 10, is of a uniform shape, which requires the use of chaplets to stabilize the core in order to maintain consistent shape throughout the length of the molded product.

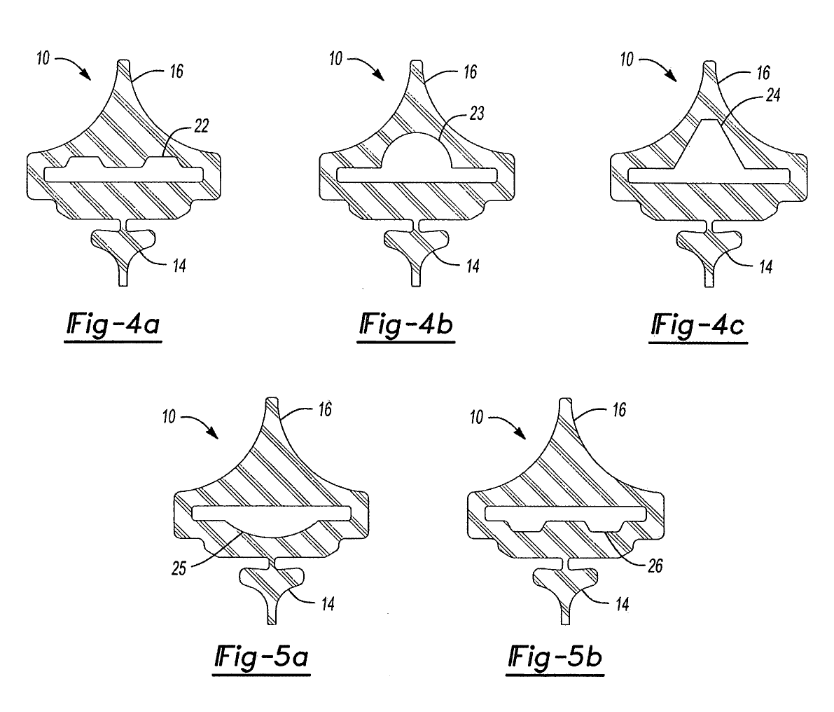

FIGS. 4a-4c illustrate three separate embodiments of the present invention, wherein the hollow apertures 22, 23, 24 of windshield wipers 10 have various upwardly-extending cavities of varying shapes, formed by variations on the core utilized in the specific molding process.

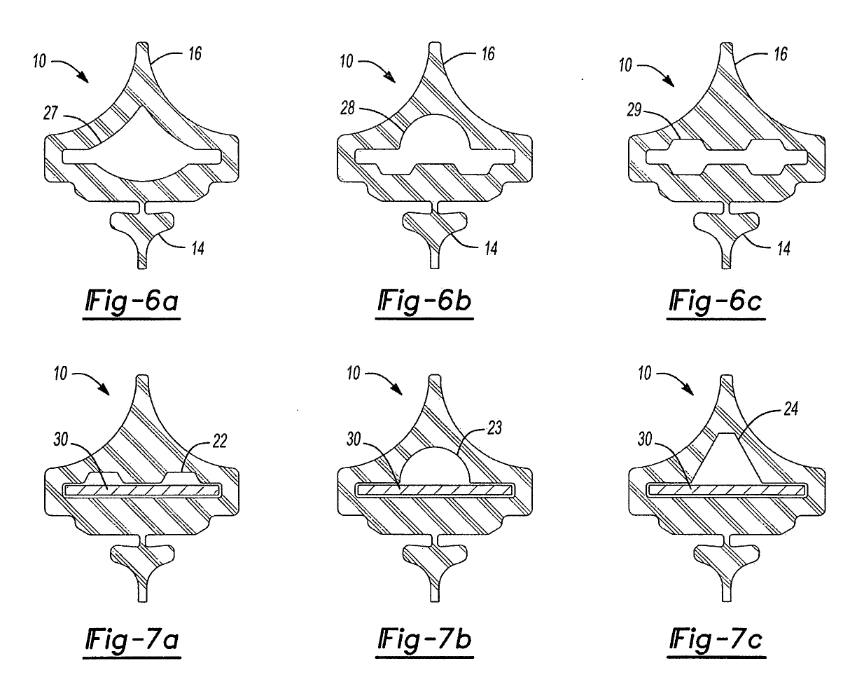

FIGS. 5a and 5b Illustrate two alternative embodiments of the present invention, wherein the hollow apertures 25, 26 of windshield wipers 10 have various downwardly-extending cavities of varying shapes, formed by variations on the core utilized in the specific molding process. FIGS. 6a-6c illustrate even further embodiments wherein the core utilized in the molding process forms both upwardly and downwardly-extending cavities in the hollow apertures 27, 28, 29 of windshield wiper 10. The windshield wiper beams 30 are shown in FIGS. 7a-7c, positioned within the apertures 22, 23, 24, respectively, after the molding process is completed and the core is removed.

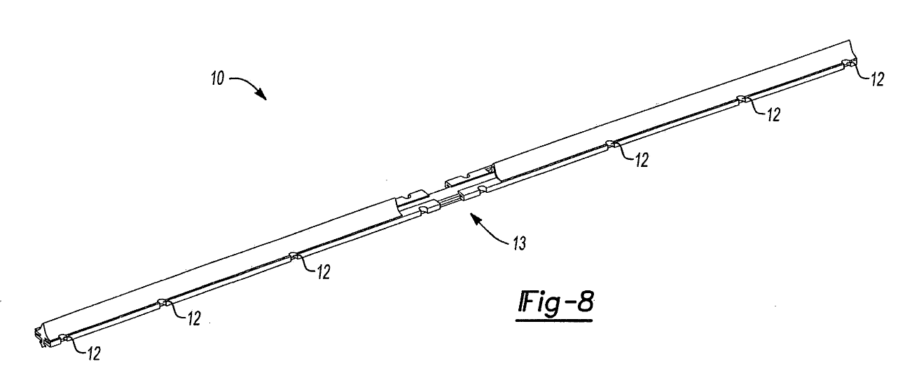

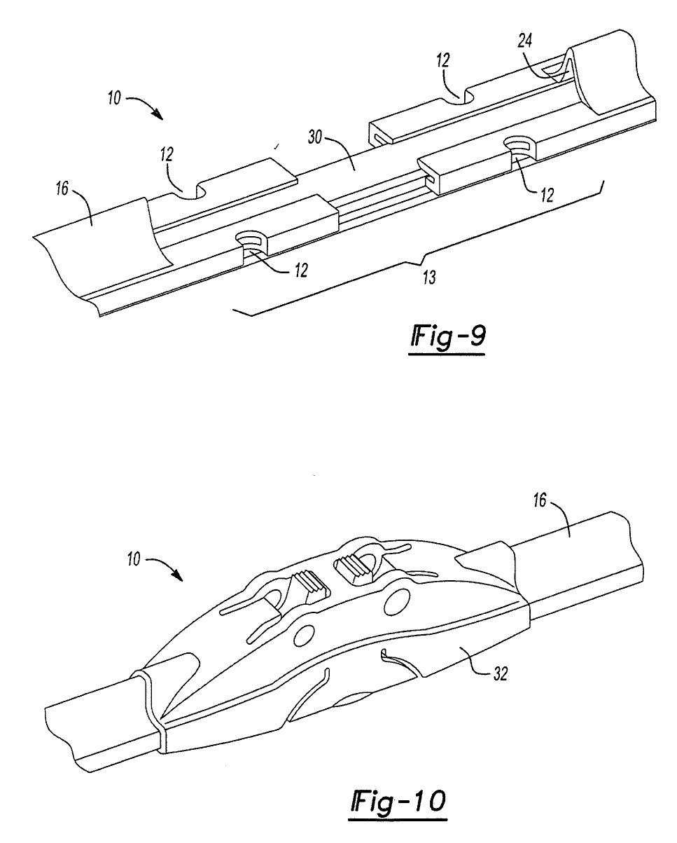

Referring now to FIG. 8, relatively-long molded products, such as windshield wiper 10, may still require the use of chaplets 12 spaced along the windshield wiper from the center mounting portion 13, although at very widely-spaced intervals compared to the relatively-close juxtaposed locations required by the prior art method shown in FIG. 2. Furthermore, as illustrated in FIGS. 9 and 10, the chaplets 12 can be positioned along windshield wiper 10 proximal the mounting portion 13, wherein they will subsequently be hidden by the attachment of the connector or shroud assembly 32, which attaches the windshield wiper 10 to a wiper arm.

Though this disclosure describes the improved molding process of windshield wiper blades, the method can be applied to numerous extended molded products wherein a longitudinal hollow is desired, such as tubes and/or hose type products, and is intended to remain within the scope of the present invention. Tangential structures located on a molding core suspended throughout the length of the cavity will eliminate or minimize the need for chaplets or other core-stabilizing means. The core is placed in the open cavity of a mold, used to manufacture rubber products, and suspended throughout the length of the cavity. The mold is then closed and rubber is introduced to the cavity by one of several normal means, such as compression, transfer, or injection processes. The tangential structures on the core will maintain the suspended position of the core as rubber flows around it, filling the cavity. After the cavity is filled and vulcanization of the rubber is complete, the mold is opened and the core is removed from the cavity with the molded product intact. Upon removal from the mold, the core is extracted from the product. The product is ready for post-molding operations and the core is returned to the mold and readied for the next molding cycle.

It is noted that the subject method may also be applied to products and processes associated with thermal plastic materials such as thermal plastic elastomers and/or other plastics. In similar fashion, the subject method has applications for certain resin materials and/or wrapped fiber materials, such as fiberglass products. Golf club shafts, extension poles used to trim trees, poles for tents and/or temporary structures, and similar products will benefit from adapted variations of this manufacturing method.

What is claimed is:

1. A method of molding an extended product having a longitudinal hollow through the center, said method comprising the steps of:
(a) manufacturing a core having a given length with a series of tangential structures positioned along the length of said core;
(b) suspending said core throughout its length within the open cavity of a mold, said mold used to manufacture polymer products;
(c) closing said mold and introducing polymer into said cavity of said mold, said tangential structures of said core maintaining the suspended position of the core as the polymer flows around said core;
(d) allowing said extended product to completely vulcanize;
(e) removing said extended product from said mold;
(f) extracting said core from said extended product; and
(g) returning said core to said mold for another molding cycle.

2. The method of molding an extended product of claim 1, wherein said polymer is selected from the group of rubber, resin, or plastic.

3. The method of molding an extended product of claim 2, wherein said series of tangential structures comprises structures on both an upper surface of said core and a lower surface of said core.

4. A method of molding an extended product having a longitudinal hollow through the center, said method comprising the steps of:
(a) manufacturing a core having a given length with a series of tangential structures positioned along the length of said core;
(b) suspending said core throughout its length within the open cavity of a mold, said mold used to manufacture polymer products, said mold having at least one core stabilizing structure proximal the center of said mold;
(c) closing said mold and introducing polymer into said cavity of said mold, said tangential structures of said core maintaining the suspended position of the core as the polymer flows around said core, said at least one core stabilizing structure of said mold forming at least one chaplet in said extended product proximal the middle of said molded element;
(d) allowing said extended product to completely vulcanize;
(e) removing said extended product from said mold;
(f) extracting said core from said extended product;
(g) returning said core to said mold for another molding cycle; and
(h) cosmetically hiding said at least one chaplet.

5. The method of molding an extended product of claim 4, wherein said polymer is selected from the group of rubber, resin, or plastic.

6. The method of molding an extended product of claim 5, wherein said series of tangential structures comprises structures on both an upper surface of said core and a lower surface of said core.
